(19) United States
(12) Patent Application Publication
(10) Pub. No.: US 2020/0300054 A1
(43) Pub. Date: Sep. 24, 2020

(54) Method for preparing artificial core to simulate fluvial sedimentary reservoir

(71) Applicant: SOUTHWEST PETROLEUM UNIVERSITY, Chengdu (CN)

(72) Inventors: Shanshan Zhu, Chengdu (CN); Leiting Shi, Chengdu (CN); Xiao Wang, Chengdu (CN); Hong Chen, Chengdu (CN); Yulong Zhang, Chengdu (CN); Zheng Shu, Chengdu (CN); Zhongbin Ye, Chengdu (CN)

(73) Assignee: SOUTHWEST PETROLEUM UNIVERSITY

(21) Appl. No.: 16/897,269

(22) Filed: Jun. 10, 2020

(30) Foreign Application Priority Data
Jun. 12, 2019 (CN) 201910508079.1

(51) Int. Cl. E21B 25/08; B28B 3/02

(52) U.S. Cl. CPC E21B 25/08; B28B 3/022

(57) ABSTRACT

A method for preparing an artificial core includes steps of: (1) preparing materials: dividing quartz sand of different particle sizes into multiple groups, adding a cementing agent into all the groups, and thoroughly stirring to obtain quartz sand mixtures with different permeabilities; (2) assembling a mold: assembling the mold into a cuboid with a hollow sand-filling groove inside; (3) wetting the mold: spraying water onto a bottom surface of the sand-filling groove with a fine water nozzle to wet the mold; (4) filling with sand: placing separators in the mold to divide the sand-filling groove into multiple parts corresponding to a group quantity of the quartz sand; sequentially pouring the quartz sand mixtures into the mold in an order from large to small particle sizes; then removing the separators, and flattening a surface of the quartz sand mixtures; (5) compacting; and (6) firing for molding and de-moulding.

### CROSS REFERENCE OF RELATED APPLICATION

The present invention claims priority under 35 U.S.C. 119(a-d) to CN 201910508079.1, tiled Jun. 12, 2019.

### BACKGROUND OF THE PRESENT INVENTION

### Field of Invention

The present invention relates to a method for preparing an artificial core to simulate a fluvial sedimentary reservoir, belonging to a technical field of artificial cores and preparation method thereof.

### Description of Related Arts

The geological conditions of offshore fluvial sedimentary reservoir are complex, wherein the thickness of the reservoir is thin, and the lateral variation is large. Natural reservoir cores are difficult to obtain. Furthermore, the volume thereof is too small, and the heterogeneity is poor, so it is impossible to simulate real situations of underground oil layers, and cannot characterize the reservoir. Laboratory experiments for studying the fluid seepage law of fluvial sedimentary reservoirs and simulating reservoir development processes are of great significance to formulate reasonable reservoir development schemes and efficiently develop the reservoir. Therefore, artificial cores are often used as simulated reservoir physical models for laboratory experiments and researches.

Conventionally, most of the artificial cores only consider common reservoir conditions and reservoir types. For example, in the paper “Technology and Application of Preparing Artificial Cores Using Quartz Sand and Epoxy Resin”, it described various types of artificial cores with different shapes and sizes; the Chinese patent application (CN 20161113882.1), i.e., “Artificial Core Preparation method for Tight Sandy Conglomerate” mainly designed a man-made core preparation method for low permeable sandy conglomerate; and the Chinese patent application “Preparation method of artificial cores with Controllable Fractures for rock fracturing performance test (CN 201711177127.0)” mainly designed a preparation method of artificial cores with fractures. None of these artificial core preparation methods involves sedimentary features of the reservoir. For reservoirs with complex geological conditions such as fluvial sediments, there is no artificial core available to simulate the fluvial sedimentary environment properly, Therefore, there is an urgency to prepare artificial cores that can simulate the fluvial sedimentary features to meet the requirements of laboratory experiments.

### SUMMARY OF THE PRESENT INVENTION

With respect to the above issues, the present invention provides a method. for preparing an artificial core of a fluvial sedimentary reservoir. The method is mainly used for preparing artificial cores for laboratory experiments to study displacement characteristics of offshore fluvial sedimentary reservoirs.

Accordingly, the present invention provides:

a method for preparing an artificial core for a fluvial sedimentary reservoir, comprising steps of:

(1) preparing materials: dividing quartz sand of different particle sizes into multiple groups, adding a cementing agent into all the groups with a mass ratio of 1:100-200, and thoroughly stirring to obtain quartz sand mixtures with different permeabilities;

(2) assembling a mold: assembling the mold into a cuboid with a hollow sand-filling groove inside and an internal wall roughness Ra≤0.025 μm;

(3) wetting the mold: spraying water onto a bottom surface of the sand-filling groove with a fine water nozzle, so as to wet the mold;

(4) filling with sand: placing separators at preset positions in the mold to divide the sand-filling groove into multiple parts corresponding to a group quantity of the quartz sand; sequentially pouring the quartz sand mixtures with the different permeabilities into the sand-filling groove in an order from large to small particle sizes; then slowly removing the separators, and moving a flattening tool back and forth along a horizontal direction in the mold until a surface of the quartz sand mixtures are flattened;

(5) compacting: pressing the quartz sand mixtures with a press block, and placing the filled mold on a hydraulic press; pre-pressing for 30 min under a pressure of 50-80 MPa, and then stabilizing with the hydraulic press at 50 MPa for 30 min before relieving; and

(6) molding and de-moulding: putting the mold of the artificial core with the press block in a thermostatic oven under a temperature of 200° C. for 12-24 h; then placing the molded artificial core on the hydraulic press, and pressing the press block to release and collect the artificial core from the mold.

Preferably, in the step (1), the quartz sand is divided into three groups with equal volumes; particle sizes of the three groups are: 60-80 meshes, 80-100 meshes, and 100-120 meshes.

Preferably, geometric dimensions of the sand-filling groove are: length×width×height=300 mm×45 mm×135 mm.

Preferably, in the step (3), 0.3-0.5 g water is used for wetting.

Preferably, in the step (3), a ratio of a volume of the water for wetting to a bottom surface area of the sand-filling groove is 2.22×10⁻⁵-3.70×10⁻⁵ g: 1.0 mm².

Preferably, in the step (4), an quantity of the separators is two, and the separators are rectangular iron pieces with a length×width of 280 mm×45 mm and 534 mm×45 mm, respectively; the two rectangular iron pieces form two semi-ellipses with long radii of 127 mm and 254 mm and short radii of 22.5 mm in the sand-filling groove; then shapes of the rectangular iron pieces are fixed to divide a volume of the sand-filling groove into three equal parts.

Preferably, the cementing agent is epoxy resin.

Beneficial effects of the present invention are as follows.

According to the present invention, the artificial core is prepared for laboratory experiments which can simulate characteristics of the fluvial sedimentary reservoirs. The core has sedimentary characteristics of the fluvial sedimentary reservoirs, and can replace natural cores of the fluvial sedimentary reservoirs for laboratory experiments and researches, which is conducive to experiments to study the fluvial sedimentary reservoirs.

### BRIEF DESCRIPTION OF THE DRAWINGS

FIG. 1 is a sketch view of an artificial core of the present invention;

FIG. 2 is a sketch view of prepared artificial core of the present invention.

### DETAILED DESCRIPTION OF THE PREFERRED EMBODIMENT

Specific implementation of the present invention will be further described below in conjunction with an embodiment, and the embodiment is not intended to limit the scope of the present invention.

A method for preparing an artificial core for a fluvial sedimentary reservoir is provided, comprising steps of:

(1) preparing materials: adding a cementing agent into quartz sand with particle sizes of 60-80 meshes, 80-100 meshes, and 100-120 meshes, wherein a mass ratio of the cementing agent to the quartz sand is 1:100; thoroughly stirring to obtain quartz sand mixtures with equal volumes and sequentially decreasing permeabilities;

(2) assembling a mold: assembling the mold into a cuboid with a hollow sand-filling groove inside and an internal wall roughness Ra≤0.025 μm; wherein geometric dimensions of the sand-filling groove are: length×width×height=300 mm×45 mm×135 mm;

(3) wetting the mold: spraying water onto a bottom surface of the sand-filling groove with a fine water nozzle, so as to wet the mold; wherein 0.3-0.5 g water is used for wetting;

(4) filling with sand: placing two separating iron pieces at preset positions in the mold, wherein the iron pieces are rectangular with a length×width of 280 mm×45 mm and 534 mm×45 mm, respectively; the two iron pieces form two semi-ellipses with long radii of 127 mm and 254 nm and short radii of 22.5 mm in the sand-filling groove; then shapes of the iron pieces are fixed to divide a. volume of the sand-filling groove into three equal parts; sequentially pouring the quartz sand mixtures with the different permeabilities obtained in the step (1) into the sand-filling groove in an order from large to small particle sizes; then slowly removing the iron pieces, and moving a flattening tool back and forth along a horizontal direction in the mold until a surface of the quartz sand mixtures are flattened;

(5) compacting: pressing the quartz sand mixtures with a press block, and placing the filled mold on a hydraulic press; pre-pressing for 30 min under a pressure of 80 MPa, and then stabilizing with the hydraulic press at 50 MPa for 30 min before relieving; and

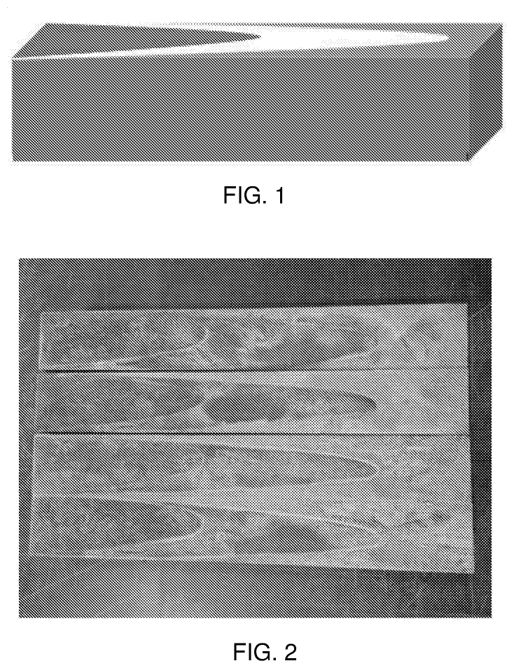

(6) molding and de-moulding: putting the mold of the artificial core with the press block in a thermostatic oven, under a temperature of 200° C. for 12 h; then placing the molded artificial core on the hydraulic press, and pressing the press block to release and collect the artificial core from the mold as shown in FIGS. 1 and 2.

What is claimed is:

1. A method for preparing an artificial core for a fluvial sedimentary reservoir, comprising steps of:
(1) preparing materials: dividing quartz sand of different particle sizes into multiple groups, adding a cementing agent into all the groups with a mass ratio of 1:100-200, and thoroughly stirring to obtain quartz sand mixtures with different permeabilities;
(2) assembling a mold: assembling the mold into a cuboid with a hollow sand-filling groove inside and an internal wall roughness Ra≤0.025 μm;
(3) wetting the mold: spraying water onto a bottom surface of the sand-filling groove with a fine water nozzle, so as to wet the mold;
(4) filling with sand: placing separators at preset positions in the mold to divide the sand-filling groove into multiple parts corresponding to a group quantity of the quartz sand; sequentially pouring the quartz sand mixtures with the different permeabilities into the sand-filling groove in an order from large to small particle sizes; then slowly removing the separators, and moving a flattening tool back and forth along a horizontal direction in the mold until a surface of the quartz sand mixtures are flattened;
(5) compacting: pressing the quartz sand mixtures with a press block, and placing the filled mold on a hydraulic press; pre-pressing for 30 min under a pressure of 50-80 MPa, and then stabilizing with the hydraulic press at 50 MPa for 30 min before relieving; and
(6) molding and de-moulding: putting the mold of the artificial core with the press block in a thermostatic oven under a temperature of 200° C. for 12-24 h; then placing the molded artificial core on the hydraulic press, and pressing the press block to release and collect the artificial core from the mold.

2. The method, as recited in claim 1, wherein in the step (1), the quartz sand is divided into three groups with equal volumes; particle sizes of the three groups are: 60-80 meshes, 80-100 meshes, and 100-120 meshes.

3. The method, as recited in claim 1, wherein geometric dimensions of the sand-filling groove are: length×width×height=300 mm×45 mm×135 mm.

4. The method, as recited in claim 1, wherein in the step (3), 0.3-0.5 g water is used for wetting.

5. The method, as recited in claim 1, wherein in the step (3), a ratio of a volume of the water for wetting to a bottom surface area of the sand-filling groove is 2.22×10⁻⁵-3.70×1.0 mm².

6. The method, as recited in claim 1, wherein in the step (4), an quantity of the separators is two, and the separators are rectangular iron pieces with a length×width of 280 mm×45 mm and 534 mm×45 mm, respectively; the two rectangular iron pieces form two semi-ellipses with long radii of 127 mm and 254 mm and short radii of 22.5 mm in the sand-filling groove; then shapes of the rectangular iron pieces are fixed to divide a volume of the sand-filling groove into three equal parts.

7. The method, as recited in claim 1, wherein the cementing agent is epoxy resin.
